(19) United States
(12) Patent Application Publication
(10) Pub. No.: US 2014/0069339 A1
(43) Pub. Date: Mar. 13, 2014

(54) Knock-Down Feeder

(71) Applicants: Vincent Allan Dettore, Albany, GA (US); Glen D. Dwayne Johnson, Twin City, GA (US)

(72) Inventors: Vincent Allan Dettore, Albany, GA (US); Glen D. Dwayne Johnson, Twin City, GA (US)

(73) Assignee: Drawdy Roofing Inc, Albany, GA (US)

(21) Appl. No.: 13/608,286

(22) Filed: Sep. 10, 2012

(51) Int. Cl. A01K 5/01

(52) U.S. Cl. 119/61.2

(57) ABSTRACT

A knock-down game feeder that can be shipped in a relatively small container and assembled at or near the site of intended use. Integrated corner support members provide improved rigidity to the storage container and a means to elevate the mechanism above the substrate with tubular legs. The legs can be removed and disassembled with no tools for ease of relocation in the field.

### CROSS-REFERENCE TO RELATED APPLICATIONS

Not applicable

### BACKGROUND OF THE INVENTION

Game feeders of many types are well known to hunters and wildlife enthusiasts. Game feeders are available in many forms, but generally include a reservoir for holding feed such as corn or commercially available pellets and a device for dispensing the feed in a controlled manner. The holding reservoir has a lid which allows feed to be introduced into the reservoir when open and prevents rainwater and debris from contaminating the feed in the closed position. The bottom of the reservoir has an opening which allows feed to flow into one of two common types of dispensing devices. One common dispensing device incorporates an electric motor and a mechanical spinner plate which “slings” feed directly onto the ground or into a feeding dispenser. The second is a gravity-fed feeding trough which refills itself as feed is removed by the wild game. Gravity-fed reservoirs are elevated above the ground high enough to allow only specific animals (i.e. deer) to access to the food. Elevating feeders also serves to keep the feed in the reservoir protected until it is dispensed for consumption. Feeders can be elevated by providing a means to suspend them from a limb of other overhead structure or more commonly by providing a support structure.

Game feeder reservoirs come in varying sizes, but preferred capacities fall in the range from 250 lb to 1000 lb. Although some feeders in this capacity range are known to have plastic or cylindrical steel reservoirs (i.e. 55 gallon drums), it is more common for high-quality feeders to be constructed from metal panels which are welded together for structural integrity. Due to the relatively large size of these feeders, transportation from the manufacturer to the end user is cumbersome and costly. To overcome this obstacle, feeders have been manufactured in relatively flat sections allowing for a much smaller shipping container which can be transported more economically. The product is then assembled by the retailer or end-user at or relatively near the intended point of use. Although these products are currently available, there exists a need for a product that can be shipped in a relatively small container, assembled at or near the point of use, and provides an improved support structure integrated into the container assembly.

Prior art related to this invention are sited below:

U.S. Pat. No. 1,120,178 discloses a concept for a knock-down feeder construction with interlocking panels.

U.S. Pat. No. 4,324,202 discloses a knock-down feeder with mortise and tenon joints at each corner which connect the side panels to an internal support post.

U.S. Pat. No. 5,259,337 shows an example of a feed trough constructed utilizing inclined surfaces joined together at their adjacent edges.

The remaining sited references include a wide variety of collapsible feeders and construction methods, but are only of general interest.

### U.S. PATENT DOCUMENTS

| | | |
|---|---|---|
| 1,120,178 | Dec. 8, 1914 | Berghofer |
| 4,324,202 | Apr. 13, 1982 | Stonestreet & Rohrbaugh |
| 5,259,337 | Nov. 9, 1993 | Rasmussen |
| 5,794,563 | Aug. 18, 1998 | Klepac |
| 6,305,320 | Oct. 23, 2001 | Fore |
| 6,427,629 | Aug. 6, 2002 | Lush |
| 6,866,004 | Mar. 15, 2005 | Lush |
| 7,032,538 | Apr. 25, 2006 | Lush |
| 7,028,635 | Apr. 18, 2006 | Eastman |
| 7,185,605 | Mar. 6, 2007 | Lush |
| 7,331,308 | Feb. 19, 2008 | Smith |

### BRIEF SUMMARY OF THE INVENTION

The present invention provides a game feeder that can be packaged and shipped in a relatively small container, assembled at or near the point of use, and provides an improved structure for supporting the apparatus in a position elevated above the substrate.

The preferred embodiment of the present invention provides a game feeder apparatus with a feed holding reservoir constructed with separate panels for the top (lid), sides, and tapered bottom sections. The sides of the reservoir are formed by overlapping and connecting each of the panels at the corners. Vertical brackets and support connection members are integrated into each assembled corner and provide rigid attachment points for the support structure. The support structure is provided by tubular legs, each of which is created by assembling 2 tubes together. Each tube is not substantially longer than the maximum dimension of the main reservoir panels. One tubular member of each support leg is swaged to create a snugly fit with no fasteners. Each leg is then slid onto the support member at each corner again requiring no fasteners.

The tapered bottom panels are fastened together in an overlapping manner and provide a central opening and mounting detail for a gravity-feeder. The gravity feeder is also provided in multiple panels to further reduce the overall shipping container size. Additionally, an adapter plate can be mounted to the tapered bottom sections to allow mounting of a motorized spinner-plate feed distributor.

In a second embodiment of the invention, the lower tapered section and gravity feeder are provided as welded or pre-assembled components. This does increase the overall package size somewhat, but reduces assembly time for the end-user and still provides a package much smaller than that required by a fully assembled feeder.

### BRIEF DESCRIPTION OF THE SEVERAL VIEWS OF THE DRAWING

FIG. 1 is a perspective view of the game feeder.

FIG. 2 is a side view of the game feeder.

FIG. 3 is a section view through the corner support structures.

FIG. 4 is a detailed view of the section through the corner support structure.

### DETAILED DESCRIPTION OF THE INVENTION

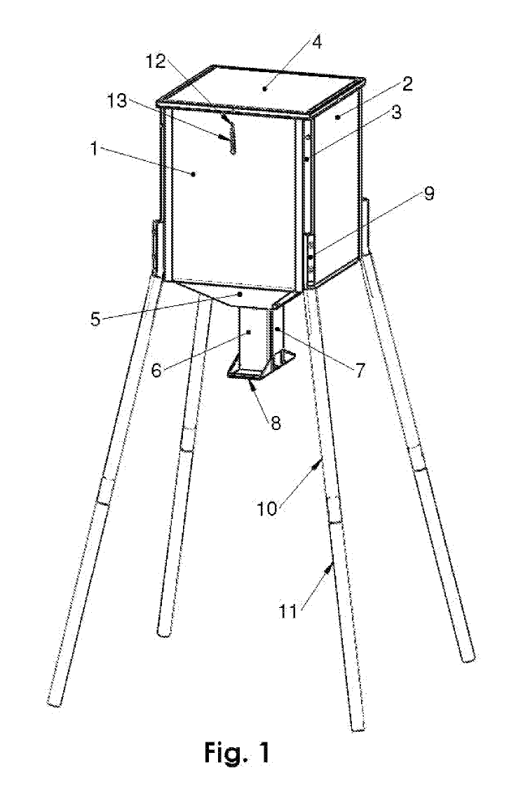

Referring to FIG. 1, items 1-5 comprise the feed holding reservoir with removable lid 4 and a central opening formed by the lower panels 5. Items 6-8 form the gravity-fed feed distributor which is attached to the lower panels 5. Items 9 are assembled to the holding reservoir 1-5 and provide attachment locations for the support legs 10-11 which maintain the apparatus in an elevated position above the substrate.

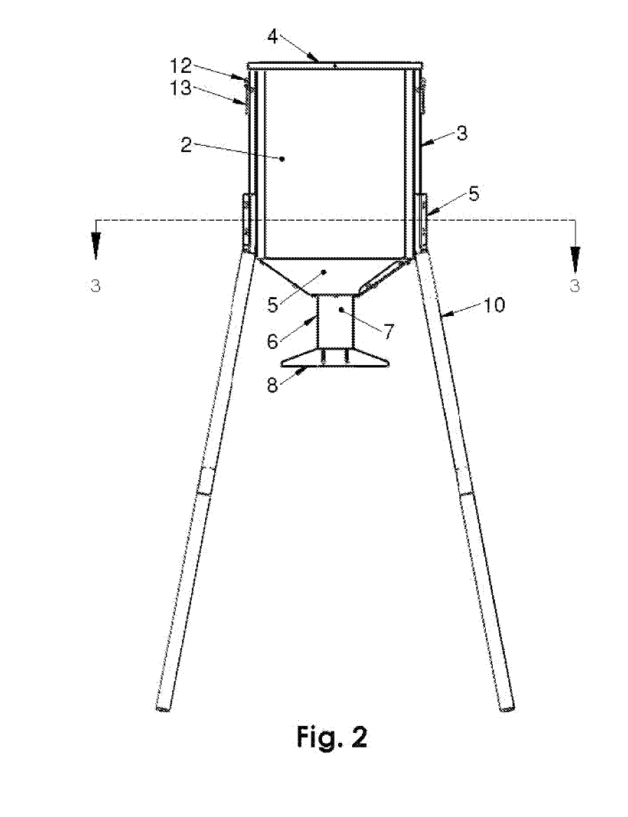

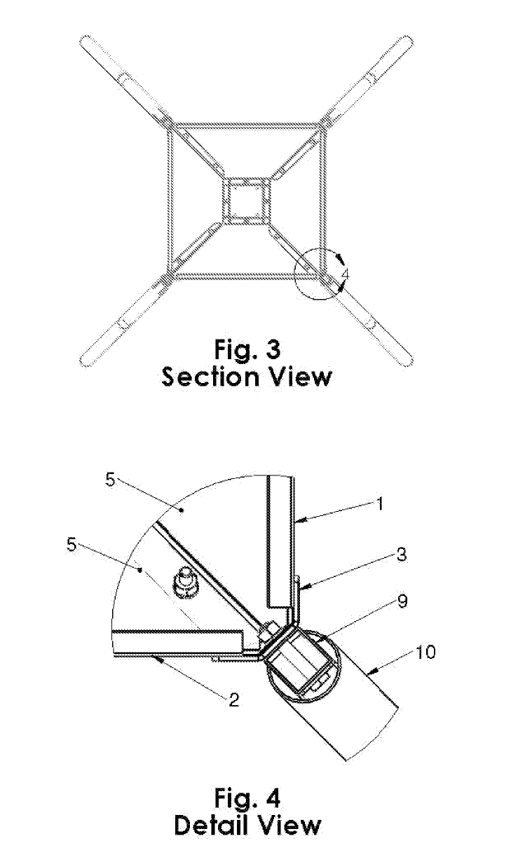

Referring also to FIG. 2, the feed reservoir is generally box-shaped and constructed utilizing four side panels 1-2. The side panels differ only in that the front and rear panels 1 provide mounting detail for a spring 13 and hook 12 which are used to secure the lid 4 in place. The panels 1-2 include formed tabs along each vertical edge which overlap with each adjacent panel at a 45 degree angle. Openings for fasteners are provided along each vertical tab. Brackets 3 are provided at each corner along with structural support members 9. Brackets 3 include 45 degree formed edges which match the side-panel attachment corner profile and fastener openings are provided to match those in the side-panel tabs. Structural support members 9 are constructed from square tubing and also have openings provided to match at least the lower two fasteners. Each side panel 1-2 has a lower edge formed at an angle greater than 90 degrees which allows the lower panel assembly (4 of item 5) to hang in place with no fasteners.

Four lower panels 5 are provided with one angled edge overlapping the adjacent panel and openings in each for at least two fasteners. The upper edges are formed at an angle greater than 90 degrees allowing the lower panel assembly to hang in place on each adjacent side-panel 1-2. The lower edges are formed to create horizontal mounting tabs with openings for attaching the gravity-feeder assembly 6-8.

The gravity feeder assembly 6-8 is constructed of two generally ell shaped sides 6-7 which interlock along vertical edges and provide tabs at each upper edge with openings to match those in the lower panels 5. Items 6-7 also provide attachment openings in each of two opposite side walls for attaching the feed tray 8. The feed tray 8 has two formed sides with slotted openings for attachment to the vertical members 6-7. The feed tray 8 slotted openings provide vertical adjustment and are secured using thumb screws for ease of adjustment.

Elevated support is achieved using tubular legs 10-11 at each corner. Upper leg 10 is a simple tube which slides over the support member 9. Lower leg 11 is swaged at the upper end to fit into upper leg 10 and extends to the substrate at the lower end.

1. An apparatus for holding and distributing feed for wild game comprising:
a container capable of holding and releasing feed including:
a structure capable of supporting said apparatus in an elevated position above the substrate.
Said structure comprised of tubular members which are removably attached to the container assembly.
a gravity-fed distribution trough removably attached to the bottom of the container.
a hinged, tethered, or removable panel forming the top of the container.
said container comprised of multiple panels creating the side walls.
each sidewall panel having a tab formed along it's vertical edges which overlap and lay flat against each adjacent panel.
each formed tab containing 2 or more openings for receiving fasteners.
support plates at a minimum of 3 vertical corners extending generally from the lower container surface upward and formed along the two vertical edges to match the contour of the corner formed by the aforementioned overlapping side wall panels.
each support plate containing openings that substantially match those in the sidewall panels for receiving aforementioned fasteners.
a support attachment member located on at least 3 support plates with openings that substantially match those in the side panel tabs and support plates for receiving aforementioned fasteners
said support attachment member providing a means to removably attach tubular support structures.
multiple tapered bottom panels that overlap and attach to one another forming a funnel for feed to flow through a central opening and into the aforementioned feeding trough.

2. The apparatus of claim 1 that utilizes multi-piece tubular legs as the support structure each of which is not substantially longer than the longest edge of the container side panels.

3. The apparatus of claim 2 where tubular legs are attached by swaging one end of each adjoining tube.

4. The apparatus of claim 1 where the support attachment is a solid or tubular member extending below the lower edge of the support plate and extending at an outward angle creating support leg contact points with the substrate at a dimension larger than the container.

5. The apparatus of claim 1 where the support attachment is sized to fit within the support tubes thus requiring no fasteners.

6. An apparatus of claim 1 that utilizes a relatively flat bottom panel.

7. An apparatus of claim 1 wherein the tapered bottom structure is a welded assembly.

8. An apparatus of claim 1 that provides an adapter plate which can be mounted to the bottom surface upon removal of the gravity feeder. Said adapter plate allows mounting of commonly available motorized disc units capable of slinging feed directly onto the substrate.
